(19) United States
(12) Patent Application Publication
(10) Pub. No.: US 2007/0012186 A1
(43) Pub. Date: Jan. 18, 2007

(54) System and method of dehumidifying and filtering air

(76) Inventor: Todd S. Wilson, Safety Harbor, FL (US)

Correspondence Address: BELL, BOYD & LLOYD, LLC, PO BOX 1135, CHICAGO, IL, 60690-1135, US

(21) Appl. No.: 11/372,960

(22) Filed: Mar. 10, 2006

Related U.S. Application Data
(60) Provisional application No. 60/661,058, filed on Mar. 11, 2005.

(51) Int. Cl. B01D 53/02

(52) U.S. Cl. 95/117; 96/134

(57) ABSTRACT

A system and method of reducing the amount of water vapor from a gas or mixture of gases such as air while removing any particulate matter from the gas. The present invention includes a dehumidifying filtering device comprising a desiccant associated with a filter medium of the device. In one embodiment, the desiccant material is contained in individual packets and distributed in association with the filter medium. In another embodiment, the desiccant material is self-contained and distributed to at least one surface of the filter medium.

### RELATED APPLICATIONS

This U.S. Utility patent application claims the benefit of U.S. Provisional Patent Application Ser. No. 60/661,058 filed on Mar. 11, 2005.

### BACKGROUND

Air is capable of carrying particles that can immediately or eventually damage or irritate anything with which the particles come into contact including components of machines or devices along with the lungs of breathing organisms.

Air is also capable of carrying moisture as a liquid vapor. Water vapor, in particular, can condense or collect on moisture-sensitive objects causing mildew, fungus, mold, rust, corrosion, swelling, degradation and other irritation or damage.

Water vapor condenses on surfaces cooler than the temperature at which air becomes saturated with moisture (dew point). Warmer air holds water more effectively than colder air, however, water vapor moves from warm air to cooler air due to the vapor pressure differential between a high vapor pressure of warm air and the lower vapor pressure of cooler air. Therefore, exposure of a column of air to objects or even other air streams having lower temperatures than the ambient air will affect whether moisture is released from the column of air. However, removing water vapor from the air (dehumidification), reduces the temperature the air must be to be saturated and thereby reduces the likelihood that the moisture will be released from the column of air.

Desiccant materials have been used to remove water vapor from air due to their high affinity for water molecules. There are two types of desiccant materials, absorbents and adsorbents. Absorbent desiccants undergo a chemical change in the presence of water. Adsorbent desiccants, on the other hand, attract water molecules to their surface and hold the water molecules in pores without chemical change to the desiccant. The porous nature of desiccant materials provide a high surface area with which to attract water molecules in the air. Subsequently, the water molecules are moved through the pores of the desiccant by capillary action to enable further adsorption of water molecules at its surface.

Devices that move air or are exposed to moving air often rely on filters to remove particulate matter from the air. However, there is a need to reduce the amount of water vapor from a column of air while removing particulates from the column of air during a single passage through a filter.

### SUMMARY

The present invention is related to an apparatus for reducing the amount of particulate matter and water vapor from a column of a gas or mixture of gases such as air and a method of accomplishing same. In particular, the present invention is directed to a dehumidification air filtration device operable to reduce the amount of water vapor from a column of air passing therethrough while removing any particulate matter from the column of air.

To this end, in an embodiment, a device is provided for reducing the amount of particles and water vapor in a column of air in a single pass through said device comprising a filter medium and a desiccant associated with the filter medium.

In an embodiment, the desiccant is associated with at least one portion of the filter medium.

In an embodiment, the desiccant is compartmentalized in a packet.

In an embodiment, the desiccant is distributed throughout the filter medium.

In an embodiment, the desiccant is selected from the group consisting of CaCl₂, calcium sulfite, MgCl₂, LiBr, LiC₁, K₂CO₃, Pb(NO₃)₂, KF, NaSO₄, K₃PO₄, CrO₃, NaNO₂, Mg(NO₃)₂, KSCN, KC₂H₃O₂, Zn(NO₃)₂, ZnBr2, K₂HPO₄, NaClO₃, impregnated or coated or chemically modified activated carbon, silica, chemically modified silica, zeolites, chemically modified zeolites, aluminas, chemically modified aluminas, molecular sieves, polyalcohols, polyethers, polysaccharides, polyacrylamides, polyacrylates, 2-acrylomido-2-methyl-1-propane-sulphonic acid, and polystyrene sulfonic acid and their salts, and combinations or mixtures thereof.

In an embodiment, the amount of desiccant associated with the filter medium is based on the surface area of the filter medium exposed to the column of air.

In a further embodiment, a method of reducing the amount of particles and the amount of water vapor in a column of air is provided comprising providing a device having a desiccant associated with a filter medium, and passing the column of air through the device.

In an embodiment, the method includes segregating the desiccant to at least one portion of the filter medium.

In an embodiment, the method includes distributing the desiccant throughout the filter medium.

In an embodiment, the desiccant is selected from the group consisting of CaCl₂, calcium sulfite, MgCl₂, LiBr, LiC₁, K₂CO₃, Pb(NO₃)₂, KF, NaSO₄, K₃PO₄, CrO₃, NaNO₂, Mg(NO₃)₂, KSCN, KC₂H₃O₂, Zn(NO₃)₂, ZnBr2, K₂HPO₄, NaClO₃, impregnated or coated or chemically modified activated carbon, silica, chemically modified silica, zeolites, chemically modified zeolites, aluminas, chemically modified aluminas, molecular sieves, polyalcohols, polyethers, polysaccharides, polyacrylamides, polyacrylates, 2-acrylomido-2-methyl-1-propane-sulphonic acid, and polystyrene sulfonic acid and their salts, and combinations or mixtures thereof.

Additional features and advantages of the present invention are described in, and will be apparent from, the following Detailed Description of the Invention and the figures.

### BRIEF DESCRIPTION OF THE FIGURES

FIG. 1 is a perspective view of one embodiment of the dehumidifying air filter of the present invention.

FIG. 2 is a perspective view of one embodiment of the dehumidifying air filter of the present invention.

FIG. 3A is a top cross-sectional view of one embodiment of the dehumidifying air filter of the present invention.

FIG. 3B is a perspective cross-sectional view of one embodiment of the dehumidifying air filter of the present invention.

### DETAILED DESCRIPTION

The present invention relates to a system and method of filtering and dehumidifying a gas or mixture of gases such as air. In particular the present invention is directed to a desiccant material associated with a filter. The filter may be employed in any system, apparatus or product that moves, conducts or is exposed to a gas or mixture of gases. The present invention is further directed to a method of using the filter to filter and dehumidify a gas or mixture of gases such as air.

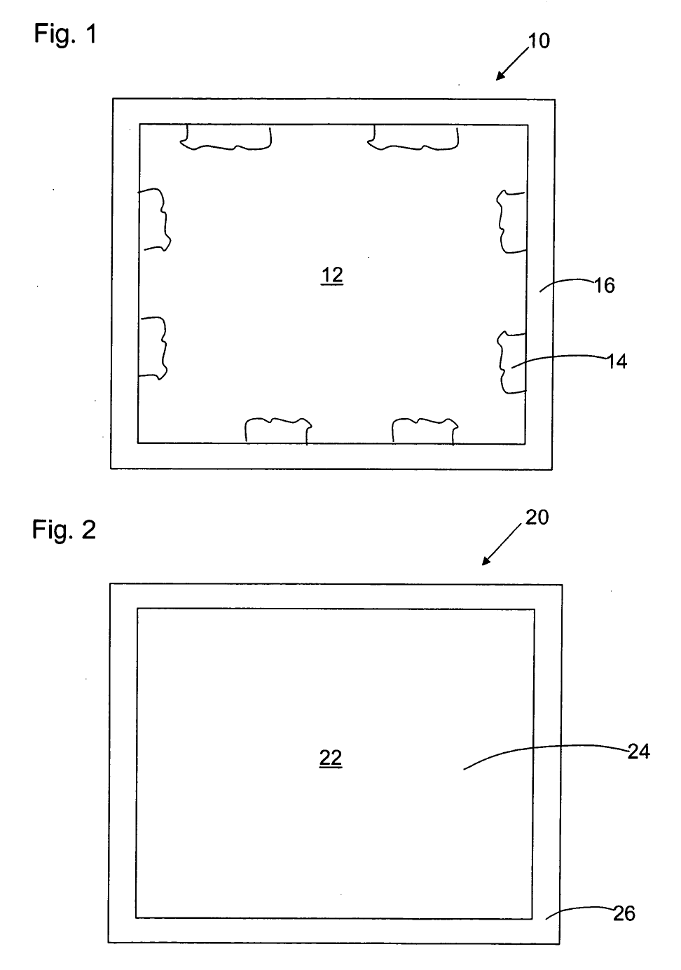

As illustrated in FIGS. 1 and 2, one embodiment of the present invention includes a filter 10, 20. The filter 10, 20 includes a filter medium 12, 22, respectively. In one embodiment, the filter medium is supported by a filter medium support structure 16, 26, respectively. At least one desiccant material 14, 24 is associated with the filter medium 12, 22, respectively.

The filter medium can include any suitable material used in an air or gas filter such as HEPA air filters, HVAC filters, ULPA filters, electrostatic filters, and any other air or gas filter.

In one embodiment, the filter medium comprises at least one material structured or arranged such that a gas or mixture of gases, such as air, can flow through the filter medium at a desirable rate. To this end, the filter may comprise a porous material and/or a material including and/or defining at least one pore through which a gas can pass.

The material of the filter medium may include natural or synthetic materials. The filter medium may include materials made of organic or inorganic compounds, including polymers, mixtures and combinations thereof.

In one embodiment, the material of the filter medium is in the form of a fiber or is fibrous. In one embodiment, the material of the filter medium can include natural fibers such as cotton or synthetic fibers such as nylon or fiberglass, for example.

The material of the filter medium may be arranged in any suitable array that enables sufficient removal of matter from the air while accommodating the conduction of a gas through the filter medium at a desirable rate.

In one embodiment, the filter medium includes fibers interwoven or intertwined in a systematic fashion to form a porous material. Alternatively, the filter medium includes fibers interwoven or intertwined in a random fashion to form a porous material. Depending on how tightly the fibers are woven together, the porous material of the filter medium may be in the form of a screen, mesh, gauze, cloth, paper or membrane-like material.

The filter medium is arrayed or structured to selectively remove certain particles from the air based on the size of the particle. To this end, the pore size of the filter medium is determined based on the size of the particle to be removed from the air conducted through the filter. The size of the particle removed from the air can occur in the range of about 0.1 μm to about 10.0 mm. In addition, pore size of the filter medium is determined based on the desired flow characteristics through the filter medium. It should be appreciated, however, that pore size may not be uniform for all pores of the filter medium.

The filter medium may form any suitable two dimensional planar shape such as a two-sided layer. The filter medium may include multiple sheets of the porous material layered together or structured to assume a more three-dimensional shape such as a block, cylinder, tube, honeycomb structure or any other suitable shape for the conduction of air through the filter. Accordingly, the filter medium includes an external surface and at least one internal surface.

In one embodiment, the filter medium is supported by a filter medium support structure. The filter medium support structure is constructed with sufficient strength and/or resilience to accommodate a tolerable range of movement of the filter medium in response to a pressure placed on the surface of the filter medium by a column of air. In FIGS. 1 and 2, for example the filter medium 12, 22 is supported about the perimeter of the filter medium by a substantially rigid rectangular frame 16, 26, respectively. In one embodiment, portions other than the perimeter of the filter medium may be supported or reinforced. For example, in one embodiment (not shown), a supportive mesh having a greater rigidity than the filter medium can be incorporated into or associated with the filter medium. In one embodiment, the filter medium support structure forms a framework or matrix with which the filter medium is associated.

The present invention may include any type of desiccant material including an absorbent desiccant and an adsorbent desiccant. The desiccant material of the present invention includes any inorganic or organic compound that is able to decrease water tension of vapor in air or has a very low vapor pressure or can extract water from humid air. Examples of inorganic absorbent desiccant materials include: CaCl₂, calcium sulfite, MgCl₂, LiBr, LiC₁, K₂CO₃, Pb(NO₃)₂, KF, NaSO₄, K₃PO₄, CrO₃, NaNO₂, Mg(NO₃)₂, KSCN, KC₂H₃O₂, Zn(NO₃)₂, ZnBr2, K₂HPO₄, NaClO₃ and combinations or mixtures thereof.

Desiccant materials may also include any solid material, in any suitable physical form, that has characteristics of adsorbing inorganic or organic molecules. The solid desiccant material may exist in any suitable physical form such as particles, nanoparticles, crystals, powder, granules, pellets, and generally every possible shape and size. In one embodiment, the solid desiccant material ranges in size from about 1 nm to about 4 mm.

Solid desiccant material may include silica, chemically modified silica (silica gel, silicates), zeolites, chemically modified zeolites, aluminas, chemically modified aluminas, molecular sieves, activated carbon, impregnated or coated or chemically modified activated carbon, and combinations or mixtures thereof. The activated carbon may be in granular, amorphous, fiber, extrudate, or powder form and can include coconut activated carbon, wood activated carbon and bituminous coal activated carbon.

Examples of organic desiccant compounds of the present invention include polyalcohols such as polyethylene glycol 300, polypropylene glycol 700, block copolymers of polyethylene glycol and polypropylene glycol, and glycerol; polyethers; polysaccharides; polyacrylamides; polyacrylates and combinations or mixtures thereof.

The desiccant material of the present invention can also include other suitable desiccant compounds such as 2-acrylomido-2-methyl-1-propane-sulphonic acid and polystyrene sulfonic acid and their salts with sodium, lithium, potassium and cesium and combinations or mixtures thereof.

Additionally, a biocide, such as antifungal or anti-mold material, may be included with or adjacent to the desiccant material. Other air purifying or conditioning materials may be used.

In one embodiment, a desiccant material is associated with the filter medium. The desiccant material may be distributed in a ubiquitous fashion throughout the filter as illustrated in FIG. 2 or segregated to at least one portion of the filter and/or compartmentalized. As illustrated in FIG. 1, the desiccant material of one embodiment of the present invention is segregated to at least one defined portion of the filter medium. The defined portion of the filter medium may be a percentage of the surface area or surface volume of the filter or filter medium. For example, in one embodiment, the desiccant material of the present invention is segregated to a defined portion that is about 0.5 to about 50% of the surface area of the filter medium. Preferably, the defined portion is about 15% of the surface area of the filter medium. It should be understood that the desiccant material can be provided at any concentration or distribution within the defined portion.

In one embodiment, as illustrated in FIG. 1, the defined portion of desiccant is compartmentalized into a structure referred to herein as a desiccant packet 18. The size of the desiccant packet may be a percentage of the surface area or surface volume of the filter or filter medium. For example, in one embodiment, the desiccant material of the present invention is segregated to a defined portion that is about 0.5 to about 50% of the surface area of the filter medium. Preferably, the size of the desiccant packet is about 15% of the surface area of the filter medium.

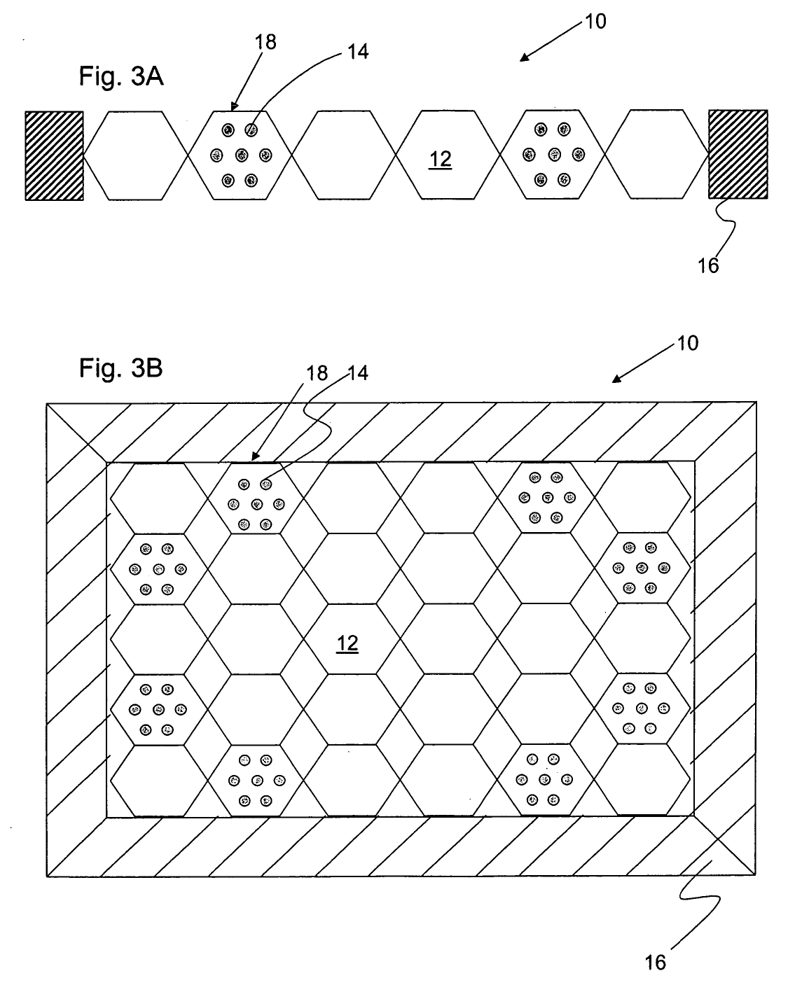

The desiccant packet may be constructed from any suitable material for containing the desiccant within a defined area or volume. The material of the desiccant packet may include the material of the filter medium, at least one material different from the material of the filter medium, the desiccant material itself and combinations and mixtures thereof. For example, the filter medium itself may be constructed in a three-dimensional form as describe above to contain the desiccant within at least one defined region of the filter medium as illustrated in FIGS. 3A and 3B. It should be appreciated that the desiccant material may be distributed in any of the three-dimensional filter medium structures illustrated in FIGS. 3A and 3B.

One embodiment of the present invention includes multiple desiccant packets. Each desiccant packet may be distributed substantially equidistant from the other desiccant packets along at least one positional axis. In one embodiment, each desiccant packet 18 is associated with areas along the perimeter of the filter medium, as illustrated in FIG. 1.

In one embodiment, the pore size of the desiccant packet material may be at least as large as the pore size of the filter medium. Additionally, in one embodiment, the density or arrangement of the desiccant material within a desiccant packet defines a pore size for airflow at least as large as the pore size of the filter medium.

In one embodiment, the amount of desiccant associated with the filter medium is related to the surface area of the filter medium through which the column of air is conducted. For example, in FIG. 1, the eight desiccant packets 18 are exposed to 16% of the total surface area of the column of air passing through the filter medium 12. The surface area exposed to the desiccant packets may include a range of about 0.5% to about 50% of the total surface area of the filter medium. It should be appreciated that the desiccant packet surface area required for adequate absorption or adsorption of moisture from a column of air may depend, in part, on the nature of the desiccant material used in the desiccant packet.

In one embodiment, the desiccant packet is distributed on the surface of the filter exposed to ambient air. In another embodiment, the desiccant packet extends beyond the surface of the filter medium through a defined region within at least part of the filter medium.

As illustrated in FIG. 2, in one embodiment of the present invention the desiccant material 24 is distributed substantially uniformly over the surface of the filter medium 22. In one embodiment, the desiccant is distributed into and throughout the filter medium.

In such an embodiment, the amount of desiccant distributed in the filter medium is related to the pore size of the filter medium. The probability of air coming into direct contact with the desiccant as it passes through the filter increases with a decrease in pore size of the filter medium or the pore size defined by the filter medium. Therefore, the present invention includes less desiccant for a smaller pore size. As discussed above, it should be appreciated that the amount of desiccant required for adequate absorption or adsorption of moisture from a column of air may depend, in part, on the nature of the desiccant material associated with the filter medium.

In addition, the size of the particles affects the amount of desiccant required for adequate absorption or adsorption of moisture from a column of air. If the desiccant consists of relatively small granules, increased surface area of the desiccant is possible in a filter medium with an increased surface area. In one embodiment, the pore size determines the size of the desiccant granules. Especially in an embodiment wherein the desiccant is not bound, affixed or adhered to the filter medium, the size of the desiccant granules is related to the pore size and the pressure generated by the column of air on the filter. This relation is directed to preventing loss of desiccant from the filter medium. Accordingly, in one embodiment, the desiccant particles will have an exterior dimension in a range of about 1-300 μm and preferably about 1-150 μm.

Desiccant material may be associated with the filter medium at any stage(s) of the production of the filter. Desiccant material may be in the form of a suspension, in the form of a deposit, or comprise at least a portion of the filter medium itself. Desiccant material may be self-contained and attached to and/or incorporated into the filter medium or fixed on a solid portion of the filter structure.

The desiccant material may be associated with the filter medium of the present invention in a variety of ways. In one embodiment, the desiccant material is incorporated into the filter medium in the absence of any physical or chemical intervention. In particular, the desiccant material is entrapped or constrained within the framework of the filter medium. For example, in an embodiment wherein the filter medium includes a mesh of fibers, the desiccant material is mixed with the fibers to be encased and held in place by the fibers of the filter medium.

Alternatively or in addition, the desiccant material is physically attached to the filter medium. In one embodiment, a binding agent is used to bind the desiccant particle to the filter medium. For example, the desiccant particles may be at least partially coated with a binding agent that enables the particles to adhere to any surface of the filter medium. The desiccant material may then be applied to the filter medium by spraying, mixing, use of an applicator or by any other suitable method of application.

In one embodiment, the desiccants of the present invention can be combined with non-evaporative organic molecules to minimize and prevent release of desiccant molecules when in contact with ambient air. The present invention can include organic molecules having low vapor pressure at ambient temperature or high boiling point such as silicon oils, high molecular weight polymers, mineral oils, organic acids, and hydrocarbons.

In one embodiment, the desiccant material is chemically attached to the filter medium. In particular, the desiccant material and/or the filter medium can be chemically modified to bind the desiccant to the filter medium.

The filter of the present invention may be a filter containing desiccant material capable of being re-charged or, alternatively, the dehumidifying filter can be replaced when the filter and/or its desiccant is no longer effective.

In one embodiment, the effectiveness of the desiccant of the filter is substantially restored by removing humidity or moisture absorbed by the desiccant by creating a vacuum or low pressure to induce evaporation of the humidity or moisture or any other suitable method known in the art.

In another embodiment, the desiccant material is exposed to an air stream having a high relative humidity, allowing it to attract and retain some of the water vapor and then exposing the same desiccant material to an air stream with a lower relative humidity which has the effect of drawing the retained moisture from the desiccant material. Generally the lower relative humidity air stream is heated to reduce its relative humidity.

An embodiment of the present invention includes a method of reducing the amount of water vapor in a gas or mixture of gases such as air. The method includes providing a dehumidifying filtering device having at least one desiccant associated with a filter medium of the device. A column of air is passed through the dehumidifying filtering device to reduce the amount of water vapor in the column of air while reducing the amount of particulate matter in the air.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A device for reducing the amount of particles and water vapor in a column of air in a single pass through said device comprising:
a filter medium; and
a desiccant associated with the filter medium.

2. The device of claim 1, wherein the desiccant is associated with at least one portion of the filter medium.

3. The device of claim 2, wherein the desiccant is compartmentalized in a packet.

4. The device of claim 1, wherein the desiccant is distributed throughout the filter medium.

5. The device of claim 1, wherein the desiccant is selected from the group consisting of CaCl₂, calcium sulfite, MgCl₂, LiBr, LiC₁, K₂CO₃, Pb(NO₃)₂, KF, NaSO₄, K₃PO₄, CrO₃, NaNO₂, Mg(NO₃)₂, KSCN, KC₂H₃O₂, Zn(NO₃)₂, ZnBr2, K₂HPO₄, NaClO₃, impregnated or coated or chemically modified activated carbon, silica, chemically modified silica, zeolites, chemically modified zeolites, aluminas, chemically modified aluminas, molecular sieves, polyalcohols, polyethers, polysaccharides, polyacrylamides, polyacrylates, 2-acrylomido-2-methyl-1-propane-sulphonic acid, and polystyrene sulfonic acid and their salts, and combinations or mixtures thereof.

6. The device of claim 1, wherein the amount of desiccant associated with the filter medium is based on the surface area of the filter medium exposed to the column of air.

7. A method of reducing the amount of particles and the amount of water vapor in a column of air comprising:
a) providing a device having a desiccant associated with a filter medium; and
b) passing the column of air through the device.

8. The method of claim 7, which includes segregating the desiccant to at least one portion of the filter medium.

9. The method of claim 7, which includes distributing the desiccant throughout the filter medium.

10. The method of claim 7, wherein the desiccant is selected from the group consisting of CaCl₂, calcium sulfite, MgCl₂, LiBr, LiC₁, K₂CO₃, Pb(NO₃)₂, KF, NaSO₄, K₃PO₄, CrO₃, NaNO₂, Mg(NO₃)₂, KSCN, KC₂H₃O₂, Zn(NO₃)₂, ZnBr2, K₂HPO₄, NaClO₃, impregnated or coated or chemically modified activated carbon, silica, chemically modified silica, zeolites, chemically modified zeolites, aluminas, chemically modified aluminas, molecular sieves, polyalcohols, polyethers, polysaccharides, polyacrylamides, polyacrylates, 2-acrylomido-2-methyl-1-propane-sulphonic acid, and polystyrene sulfonic acid and their salts, and combinations or mixtures thereof.
